(19) United States
(12) Patent Application Publication
(10) Pub. No.: US 2026/0183582 A1
(43) Pub. Date: Jul. 2, 2026

(54) FIRE EXTINGUISHING SYSTEM FOR UNCONVENTIONAL OIL PRODUCTION PLANTS

(71) Applicant: Koms Co. Ltd., Busan (KR)

(72) Inventors: Hyun Kook KIM, Busan (KR); Sang Ho CHA, Busan (KR); Hyeon Seong CHOI, Busan (KR)

(73) Assignee: Koms Co. Ltd., Busan (KR)

(21) Appl. No.: 19/433,422

(22) Filed: Dec. 26, 2025

(30) Foreign Application Priority Data
Dec. 27, 2024 (KR) 10-2024-0197888

(51) Int. Cl. A62C 3/06; A62C 37/40

(52) U.S. Cl. CPC A62C 3/06; A62C 37/40

(57) ABSTRACT

A fire extinguishing system for unconventional oil production plants comprises a rail provided at a predetermined height above a ground around facilities of a plant for producing unconventional oil; a fire suppression mobile robot configured to monitor in real time whether a fire has occurred in the facility and in a vicinity of the facility while moving along the rail, to transmit a fire signal via a network upon detecting occurrence of the fire, and to spray a fire extinguishing agent onto an object where the fire has occurred; and a control server configured to activate a fire alarm in the plant upon receiving the fire signal from the fire suppression mobile robot, to transmit the fire situation externally via the network, and to control movement and operation of the fire suppression mobile robot.

### CROSS-REFERENCE TO RELATED APPLICATIONS

The present application claims priority to KR 10-2024-0197888 filed December 27, 2024 in the Korean Intellectual Property Office, the disclosure of which is incorporated herein by reference in its entirety.

### STATEMENT REGARDING GOVERNMENT SPONSORED RESEARCH

This invention was supported by the Korea Agency for Infrastructure Technology Advancement (KAIA) and the Ministry of Land, Infrastructure and Transport. [Research Project name: "R&D Program for Key Technologies in Construction of Unconventional Oil Production Plants"; Research Subject name: "Technology Development of Modular Design and Integrated Demonstration for Oil Production Plants"; Project Serial Number: 1615012996; Research Subject Number: 00143644]

### BACKGROUND OF THE INVENTION

### FIELD OF THE INVENTION

The present invention relates to a fire extinguishing system, and more particularly to a fire extinguishing system for unconventional oil production plants capable of rapidly and effectively extinguishing fires occurring in plants that produce unconventional oil, such as from oil sands.

### DESCRIPTION OF THE RELATED ART

Due to the recent rise in international oil prices, the need to develop unconventional resources, which extract crude oil through processing, has become prominent. Consequently, the development of unconventional resources such as oil sands is being accelerated. Oil sands contain bitumen, sand, water, clay, and trace minerals, among which bitumen is the key component that gives oil sands their significance as a petroleum resource.

An oil sand production plant includes various facilities such as a free water knockout (FWKO) system, a steam generator, a well pad, an oil injection tank, a water removal tank, a steam tank, a pipe rack, and a pipe. In particular, the pipe that connects the facilities of the oil sand production plant to each other plays a crucial role in ensuring the smooth operation of an oil production process, thus requiring structural stability.

However, since fluids such as oil and water move along the pipe, there is a risk of safety incidents such as fires or explosions due to fatigue-induced cracks, breakage, etc. Safety incidents may cause severe loss of life and property damage, and operational shutdowns increase the cost and time required to resume oil production.

Furthermore, Canada, which is a major oil sand area, is vulnerable to large wildfires, and most oil sand production plants rely on a fire extinguishing system that requires manual labor. During severe cold periods, deploying personnel is nearly impossible, making initial fire extinguishing difficult when a fire occurs.

### Prior Art Document

### Patent Document

(Patent Document 1) Korean Registered Patent No. 10-1992220 entitled Plant Facility Monitoring System

### SUMMARY OF THE INVENTION

The present invention has been made in view of the above problems, and it is an object of the present invention to provide a fire extinguishing system for unconventional oil production plants capable of monitoring plants that produce unconventional oil, such as oil sands, in real time to prevent fires and performing rapid and effective fire extinguishment when a fire occurs.

In accordance with the present invention, the above and other objects can be accomplished by the provision of a fire extinguishing system for unconventional oil production plants, the fire extinguishing system including a rail provided at a predetermined height above the ground around facilities of a plant for producing unconventional oil, a fire suppression mobile robot configured to monitor in real time whether a fire has occurred in the facility and in the vicinity of the facility while moving along the rail, to transmit a fire signal via a network upon detecting occurrence of the fire, and to spray a fire extinguishing agent onto an object where the fire has occurred, and a control server configured to activate a fire alarm in the plant upon receiving the fire signal from the fire suppression mobile robot, to transmit the fire situation externally via the network, and to control movement and operation of the fire suppression mobile robot.

The fire suppression mobile robot may include a transfer body movably coupled to the rail extending therethrough in a forward-backward direction, the transfer body being provided with an environmental sensor configured to measure the concentration of gas in the air, and a monitoring and suppression body coupled to a lower side of the transfer body, the monitoring and suppression body including a thermal imaging camera configured to capture a thermal image and a visible image, an ultrasonic camera configured to detect cracks or damage in the facility, and a fire nozzle configured to spray a fire extinguishing agent, the monitoring and suppression body may be coupled to the transfer body so as to rotate about a vertical axis, and the thermal imaging camera, the ultrasonic camera, and the fire nozzle may be configured to be turned in an upward-downward direction.

The monitoring and suppression body may be provided therein with a plurality of fire extinguishing agent storage tanks configured to store different types of fire extinguishing agents, respectively, a plurality of first transfer pipes connected to each of the fire extinguishing agent storage tanks, a second transfer pipe connected to the fire nozzle, a valve configured to allow one of the plurality of first transfer pipes and the second transfer pipe to communicate with each other therethrough, and a fire extinguishing agent pump provided on the second transfer pipe, the fire extinguishing agent pump being configured to spray the fire extinguishing agent stored in the fire extinguishing agent storage tank to the fire nozzle via the first transfer pipe and the second transfer pipe.

The fire suppression mobile robot may further include a battery configured to supply electricity necessary for movement on the rail and electricity necessary for operation of components provided in the transfer body and the monitoring and suppression body, and the fire extinguishing system may further include a charging station provided at at least one point on the rail, the charging station having a charging module configured to charge the battery.

The fire extinguishing system may further include a hose tank provided in the vicinity of the charging station, the hose tank being configured to store the same fire extinguishing agent as the fire extinguishing agent stored in any one of the plurality of fire extinguishing agent storage tanks, the hose tank being provided with a supply pump configured to supply the stored fire extinguishing agent to the outside, wherein the charging station may further include a fire hose having one end coupled to the monitoring and suppression body so as to communicate with the fire extinguishing agent storage tank in which the fire extinguishing agent is stored and the other end connected to the supply pump, the fire hose being configured to undergo continuous elastic coiling over a predetermined length, a coiled upper point of the fire hose being connected to the rail via a hose guide movable along the rail.

The fire suppression mobile robot may further include a bucket moving rail provided under the monitoring and suppression body, and a bucket module configured to store fire extinguishing water may be coupled to the bucket moving rail.

The fire suppression mobile robot may be provided in plural so as to transfer the bucket module while moving along the same rail, the bucket module may include a bucket configured to receive fire extinguishing water and a bucket moving mechanism configured to move the bucket in the upward-downward direction, an upper end of the bucket moving mechanism being coupled to the bucket moving rail, and the bucket moving rail may be formed in a straight configuration and integrally coupled to a lower surface of the monitoring and suppression body, the bucket moving rail being provided in an inside thereof with a rail groove configured to allow the bucket moving mechanism to move there along such that both ends of the bucket moving rail in a longitudinal direction communicate with an outside, a first movement restriction plate and a second movement restriction plate configured to open or close the rail groove and to block or allow movement of the bucket moving mechanism in one direction and the other direction, respectively, being turnably provided on the rail groove.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a view showing the configuration of a fire extinguishing system according to the present invention;

FIG. 2 is a view schematically showing an example in which the fire extinguishing system according to the present invention is applied to an unconventional oil production plant;

FIGS. 3A and 3B are a view showing a fire suppression mobile robot according to an example applied to the fire extinguishing system according to the present invention;

FIG. 4 is a view showing the interior of a monitoring and suppression body of the fire suppression mobile robot applied to the fire extinguishing system according to the present invention;

FIG. 5 is a view showing that the fire suppression mobile robot can be charged by a charging station applied to the fire extinguishing system according to the present invention;

FIG. 6 is a view showing that the fire suppression mobile robot applied to the fire extinguishing system according to the present invention can be connected to a fire hose provided at the charging station;

FIG. 7 is a view showing an example in which the fire suppression mobile robot applied to the fire extinguishing system according to the present invention moves with the fire hose connected thereto;

FIGS. 8A and 8B are a view showing a fire suppression mobile robot according to another example applied to the fire extinguishing system according to the present invention;

FIG. 9 is a view showing a state in which a bucket module is coupled to the fire suppression mobile robot according to the other example applied to the fire extinguishing system according to the present invention; and

FIGS. 10 to 12 are views showing a process in which the bucket module is transferred from one fire suppression mobile robot to another.

### DETAILED DESCRIPTION OF THE INVENTION

In order to monitor a plant that produces unconventional oil, such as from oil sands, in real time to prevent fires and performing rapid and effective fire extinguishment when a fire occurs, the present invention proposes a fire extinguishing system for unconventional oil production plants, the fire extinguishing system including a rail provided at a predetermined height above the ground around facilities of a plant for producing unconventional oil, a fire suppression mobile robot configured to monitor in real time whether a fire has occurred in the facility and in the vicinity of the facility while moving along the rail, to transmit a fire signal via a network upon detecting occurrence of the fire, and to spray a fire extinguishing agent onto an object where the fire has occurred, and a control server configured to activate a fire alarm in the plant upon receiving the fire signal from the fire suppression mobile robot, to transmit the fire situation externally via the network, and to control the movement and operation of the fire suppression mobile robot.

In the present invention, the network may be at least one of a WAN (Wide Area Network), a MAN (Metropolitan Area Network), a LAN (Local Area Network), or a combination thereof. Furthermore, the network may be implemented using wireless internet technologies such as WLAN (Wireless LAN) (Wi-Fi), WiBro (Wireless broadband), and/or WiMAX (World Interoperability for Microwave Access), or mobile communication technologies such as CDMA (Code Division Multiple Access), GSM (Global System for Mobile communication), LTE (Long Term Evolution), and/or LTE-Advanced.

Furthermore, in this specification, the server may include a DB, which means a functional and structural combination of software and hardware that stores information corresponding to each database. The DB may be implemented as at least one table and may further include a separate database management system (DBMS) for retrieving, storing, and managing information stored in the database. Furthermore, the DB may be implemented in various types, such as a linked list, a tree, or a relational database, and includes all data storage media and data structures capable of storing information corresponding to the database.

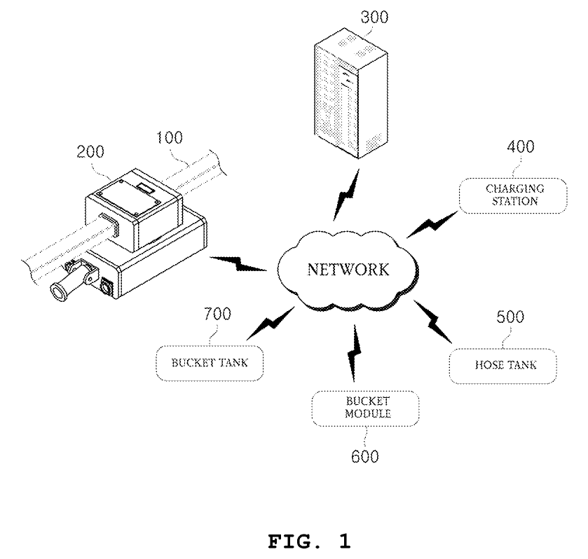

Hereinafter, a fire extinguishing system for unconventional oil production plants according to the present invention will be described in detail with reference to FIGS. 1 to 12.

As shown in FIG. 1, the fire extinguishing system for unconventional oil production plants according to the present invention includes a rail 100, a fire suppression mobile robot 200, and a control server 300. The fire extinguishing system according to the present invention is applied to a plant for producing unconventional oil, such as from oil sands or oil shale, and is configured to monitor for fires at the plant and in the vicinity thereof and to extinguish fires when the fires occur.

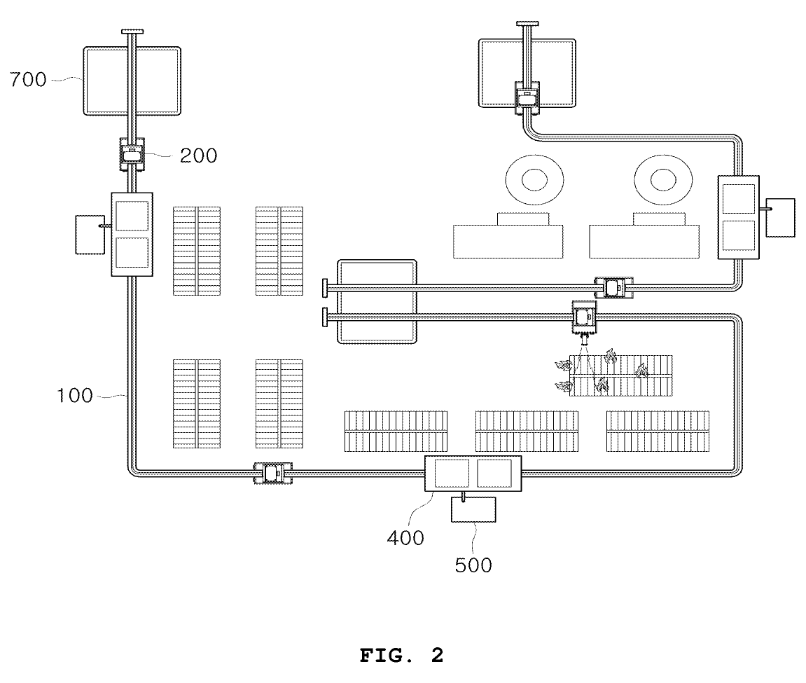

As shown in FIG. 2, the rail 100 is provided along facilities of the unconventional oil production plant at a predetermined height above the ground to provide a path for the fire suppression mobile robot 200 to move. Here, the facilities of the plant may include a free water knockout (FWKO) system, a steam generator, a well pad, an oil injection tank, a water removal tank, a steam tank, a pipe rack, and a pipe. Among the facilities constituting the unconventional oil production plant, the pipe serves to connect various other facilities to each other and is therefore configured so as to extend through various other facilities in the plant. As an example, the rail 100 may be configured to have the same path as or a similar path to the facilities of the plant along which the rail 100 is installed. In this case, considering potential fires originating from the pipe, it is desirable to provide the rail 100 above the pipe.

As shown in FIG. 2, the fire suppression mobile robot 200 is configured to move along the rail 100, and monitors in real time whether a fire has occurred in the facilities of the plant and in the vicinity of the facilities while moving along the rail 100. In addition, as shown in FIG. 1, upon detecting a fire, the fire suppression mobile robot 200 may transmit a fire signal externally, such as to the control server 300, via the network and spray a fire extinguishing agent onto an object where the fire has occurred. Furthermore, the fire suppression mobile robot 200 may transmit a monitored image, a sensor measurement, etc. to the control server 300 via the network.

The fire suppression mobile robot 200 may be provided in plural so as to move along the same rail 100. In this case, the rail 100 may be divided into sections each having a predetermined length, and at least one of the plurality of fire suppression mobile robots 200 may be disposed in each section to perform fire monitoring and fire extinguishing functions while moving along the section.

Upon receiving the fire signal from the fire suppression mobile robot 200, the control server 300 may activate a fire alarm, such as a voice alert, a siren, or a visual fire alarm, in the plant and transmit the fire situation externally (e.g., to a fire control system) via the network. Here, the fire situation transmitted externally may refer to an image of the object where the fire has occurred, monitored by the fire suppression mobile robot 200.

The control server 300 controls the movement and operation of the fire suppression mobile robot 200 based on monitored information and whether the fire has occurred. As an example, the control server 300 may move the fire suppression mobile robot 200 to monitor the entirety or a part of the rail 100 for fire occurrence during normal operation. Furthermore, upon detecting the fire, the control server 300 moves the fire suppression mobile robot 200 to the vicinity of the object where the fire has occurred and sends a fire extinguishing signal to the fire suppression mobile robot 200 such that the fire suppression mobile robot 200 can spray a fire extinguishing agent. The movement and operation of the fire suppression mobile robot 200, described below, may be performed according to a control signal from the control server 300, and a further description thereof will be omitted. Furthermore, the control server 300 may perform monitoring and operational control of a charging station 400, a hose tank 500, a bucket module 600, and a bucket tank 700, a description of which will follow, via the network, as shown in FIG. 1.

In the fire extinguishing system according to the present invention, the fire suppression mobile robot 200 monitors in real time whether a fire has occurred while moving along the rail 100 provided in the vicinity of the facilities of the plant, whereby it is possible to prevent the occurrence of fires. Furthermore, upon fire detection, the fire extinguishing robot 200 may alert the control server 300, the control server 300 may notify both the inside and the outside of the plant of the fire occurrence, and the fire suppression mobile robot 200 may spray the fire extinguishing agent toward the object where the fire has occurred, enabling rapid early extinguishment of the fire and minimizing material and human damage caused by the fire.

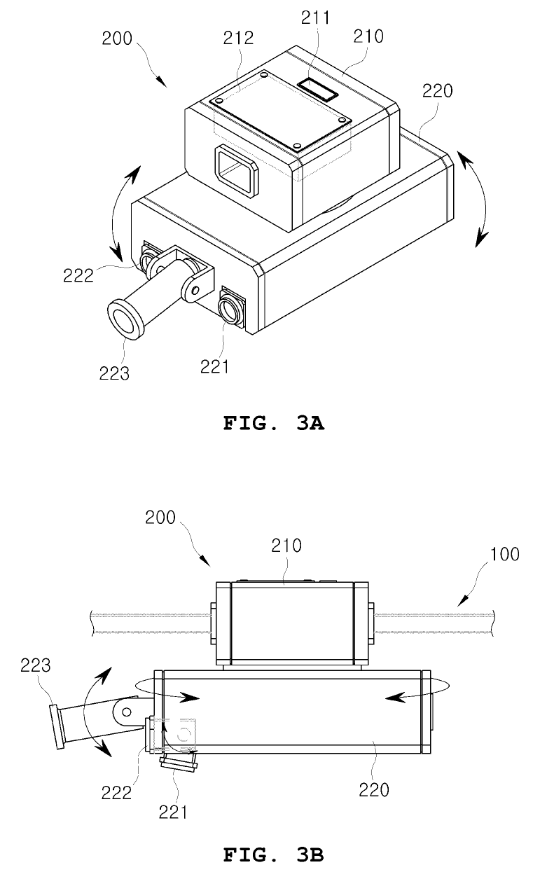

Meanwhile, as an example, the fire suppression mobile robot 200 may include a transfer body 210 movably coupled to the rail 100 and a monitoring and suppression body 220 coupled to a lower side of the transfer body 210, the monitoring and suppression body being configured to monitor the occurrence of a fire and to perform a fire suppression function. Each of the transfer body 210 and the monitoring and suppression body 220 may be formed in various external shapes and, for manufacturing convenience, may be formed in a hexahedral shape, as shown in FIGS. 3A to 12. Furthermore, for the convenience of the following description, the direction in which the fire suppression mobile robot 200 moves is referred to as a forward-backward direction.

As shown in FIGS. 3A and 3B, a rail guide, to which the rail 100 may be coupled, may be formed through the transfer body 210 in the forward-backward direction, whereby the transfer body 210 may be movably coupled to the rail 100 extending through the rail guide. The transfer body 210 may be provided with an environmental sensor 211 configured to measure the concentration of gas in the air, such as carbon monoxide, carbon dioxide, oxygen, methane, or ammonia. As an example, the environmental sensor 211 may measure not only the concentration of gas in the air but also the temperature and humidity of the gas, smoke, and volatile organic compounds, such as benzene or toluene. A sensor measurement obtained by the environmental sensor 211 may be transmitted to the control server 300 via the network, and the control server 300 may predict the fire risk level based on the sensor measurement or identify residual risk factors after fire suppression.

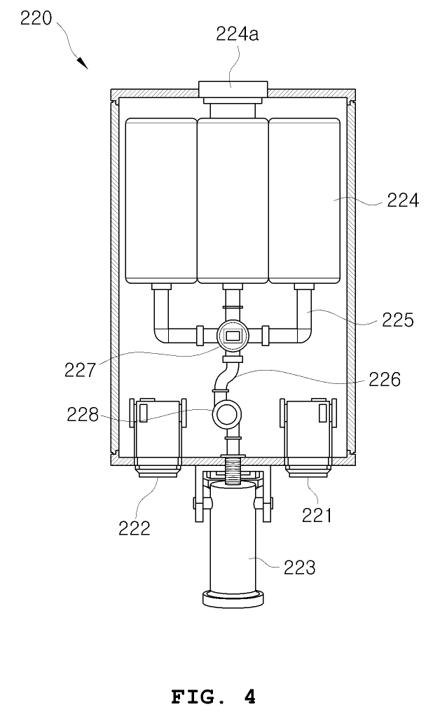

As shown in FIGS. 3A and 4, the monitoring and suppression body 220 may include a thermal imaging camera 221 configured to capture thermal and visible images, an ultrasonic camera 222 configured to detect cracks or damage in the facilities, and a fire nozzle 223 configured to spray a fire extinguishing agent. As an example, the thermal imaging camera 221 may clearly capture images of the facilities and the vicinity of the facilities through capture of the visible images and may check the heat distribution at the fire scene in real time through capture of the thermal images. Furthermore, the ultrasonic camera 222 uses ultrasonic waves to detect cracks or damage in the facilities, whereby it is possible to check risks before and after a fire. The fire nozzle 223 sprays the fire extinguishing agent onto the object where the fire has occurred to directly suppress the fire, and the spraying position may be adjusted based on thermal image data from the thermal imaging camera 221.

It is preferable for the thermal imaging camera 221, the ultrasonic camera 222, and the fire nozzle 223 to be all provided on one side of the monitoring and suppression body 220 in order to enable coordinated operation while facing the fire scene; however, the present invention is not necessarily limited thereto. Furthermore, it is preferable for the monitoring and suppression body 220 to be coupled to the transfer body 210 so as to rotate about a vertical axis and for the thermal imaging camera 221, the ultrasonic camera 222, and the fire nozzle 223 to be turned in an upward-downward direction. Consequently, the monitoring and suppression body 220 may perform fire monitoring and suppression functions in all directions.

Furthermore, while the monitoring and suppression body 220 may be configured to spray one type of fire extinguishing agent through the fire nozzle 223, appropriate extinguishing agents may be used depending on the type of fire (e.g., electrical fire or oil fire). Therefore, the fire nozzle 223 may be configured to selectively spray any one of various types of fire extinguishing agents. As an example, as shown in FIG. 4, a fire extinguishing agent storage tank 224, a first transfer pipe 225, a second transfer pipe 226, a valve 227, and a fire extinguishing agent pump 228 may be provided in the monitoring and suppression body 220.

The fire extinguishing agent storage tank 224 may be provided in plural such that different types of fire extinguishing agents can be received in the respective fire extinguishing agent storage tanks. For example, three fire extinguishing agent storage tanks 224 may be provided to store water, powder, and foam, respectively. Water may be used for fires other than electrical fires, powder may be used for electrical, oil, and combustible fires, and foam may be used to cover the combustion surface in flow channel fires in order to block fire spread.

The first transfer pipe 225 connects each fire extinguishing agent storage tank 224 and an inlet end of the valve 227 to each other, and the second transfer pipe 226 connects an outlet end of the valve 227 to the pump 228 to each other and connects the pump 228 and the fire nozzle 223 to each other. The valve 227 allows any one of the plurality of first transfer pipes 225 to communicate with the second transfer pipe 226 therethrough in order to supply only one of the different fire extinguishing agents store in the plurality of fire extinguishing agent storage tanks 224 to the fire nozzle 223. The fire extinguishing agent pump 228 is provided on the second transfer pipe 226 and causes the fire extinguishing agent stored in the fire extinguishing agent storage tank 224 to be sprayed to the fire nozzle 223 via the first transfer pipe 225 and the second transfer pipe 226.

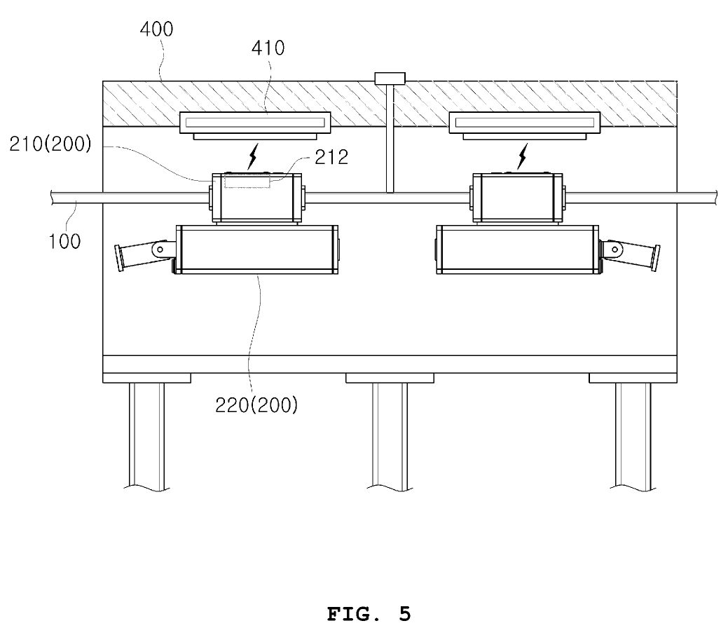

Meanwhile, the fire suppression mobile robot 200 may further include a battery 212 configured to supply electricity necessary for movement on the rail 100 and electricity necessary for operation of the components provided in the transfer body 210 and the monitoring and suppression body 220. As shown in FIGS. 3A and 5, the battery 212 may be provided in the transfer body 210 and may be charged via wired or wireless means. Furthermore, as shown in FIGS. 2 and 5, the fire extinguishing system according to the present invention may further include a charging station 400 provided at at least one point on the rail 100, the charging station 400 having a charging module 410 configured to charge the battery 212. In this case, it is preferable for charging of the battery 212 by the charging module 410 to be performed wirelessly, considering that the fire suppression mobile robot 200 is located at a predetermined height above the ground. Therefore, when the battery 212 is provided on an upper inner side of the transfer body 210, the charging module 410 may be provided on the ceiling of the charging station 400 such that, when the fire suppression mobile robot 200 is located under the charging module 410 so as to be adjacent thereto, the battery 212 can be wirelessly charged.

As shown in FIG. 2, the charging station 400 may be provided in plural along the rail 100, considering the total length of the rail 100, the performance of the battery 212, and the number of fire suppression mobile robots 200 that move along the rail 100. Furthermore, when a plurality of fire suppression mobile robots 200 each configured to move a partitioned distance is provided along the same rail 100, a charging station 400 may be provided at each partitioned point of the rail 100, and, as shown in FIG. 5, the batteries 212 of two fire suppression mobile robots 200 may be charged by a single charging station 400.

Meanwhile, while small fires can be extinguished using the fire extinguishing agent stored in the fire extinguishing agent storage tank 224 of the fire suppression mobile robot 200, it may be difficult to extinguish larger fires using the fire extinguishing agent stored in the fire extinguishing agent storage tank 224. In the present invention, therefore, an additional fire extinguishing agent may be supplied.

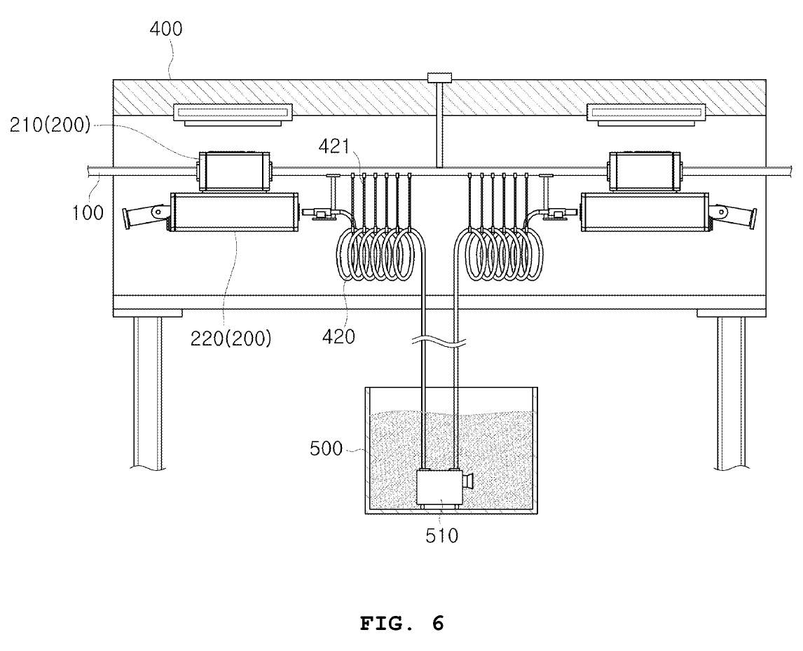

To this end, as an example, as shown in FIGS. 2 and 6, the fire extinguishing system according to the present invention may further include a hose tank 500 provided in the vicinity of the charging station 400 to store the same fire extinguishing agent as the fire extinguishing agent stored in any one of the plurality of fire extinguishing agent storage tanks 224, wherein the fire extinguishing agent stored in the hose tank 500 may be water, which is most commonly used during large-scale fires. The hose tank 500 may be provided with a supply pump 510 configured to supply the stored fire extinguishing agent to the outside. Furthermore, the charging station 400 may further include a fire hose 420 having one end connected to the fire suppression mobile robot 200 and the other end connected to the supply pump 510, wherein the fire hose 420 provides a path for the fire extinguishing agent in the hose tank 500 to be supplied to the fire suppression mobile robot 200 by the supply pump 510.

As an example, one end of the fire hose 420 may be coupled to a hose connection port 224a extending outward from the fire extinguishing agent storage tank 224 of the monitoring and suppression body 220 so as to communicate with the fire extinguishing agent storage tank 224 in which the fire extinguishing agent is stored, and the other end of the fire hose 420 may be connected to the supply pump 510. In this case, one end of the fire hose 420 is automatically coupled to the fire extinguishing agent storage tank 224 so as to communicate therewith when the fire suppression mobile robot 200 enters the charging station 400 and moves toward the fire hose 420. When the use of the fire hose 420 is completed and the fire suppression mobile robot 200 returns to the charging station 400, coupling between one end of the fire hose and the fire extinguishing agent storage tank 224 may be automatically released. As such, one end of the fire hose 420 configured to be connected to and disconnected from fire suppression mobile robot 200 in conjunction with the movement of the fire suppression mobile robot 200 may be fixed at the same height as the fire extinguishing agent storage tank 224 of the fire suppression mobile robot 200 to be located in the charging station 400 prior to coupling to the fire suppression mobile robot 200, and may move together with the fire suppression mobile robot 200 when being coupled to the fire suppression mobile robot 200.

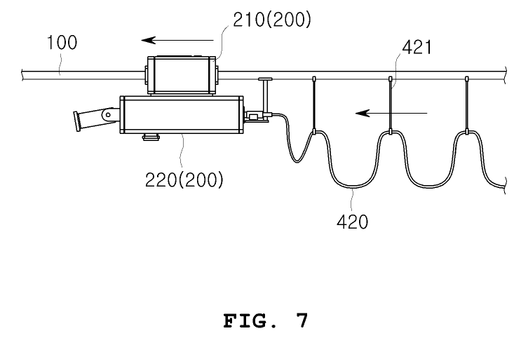

Furthermore, since the fire suppression mobile robot 200 moves a considerable distance along the rail 100, it is preferable for the fire hose 420 to be formed so as to have a sufficient length to cover the movement distance of the fire suppression mobile robot 200. The fire hose 420 of such a considerable length may be configured to undergo continuous elastic coiling in the charging station 400 over a predetermined length, and a coiled upper point of the fire hose 420 may be connected to the rail 100 via a hose guide 421 movable along the rail 100. Accordingly, when the fire suppression mobile robot 200 moves along the rail 100, as shown in FIG. 7, after one end of the fire hose 420 is coupled to the monitoring and suppression body 220, the coiled part of the fire hose 420 may be uncoiled and move along with the fire suppression mobile robot 200. Furthermore, the fire extinguishing agent stored in the hose tank 500 may be supplied to the fire extinguishing agent storage tank 224 by the operation of the supply pump 510, whereby the fire suppression mobile robot 200 may suppress the fire while continuously receiving the fire extinguishing agent.

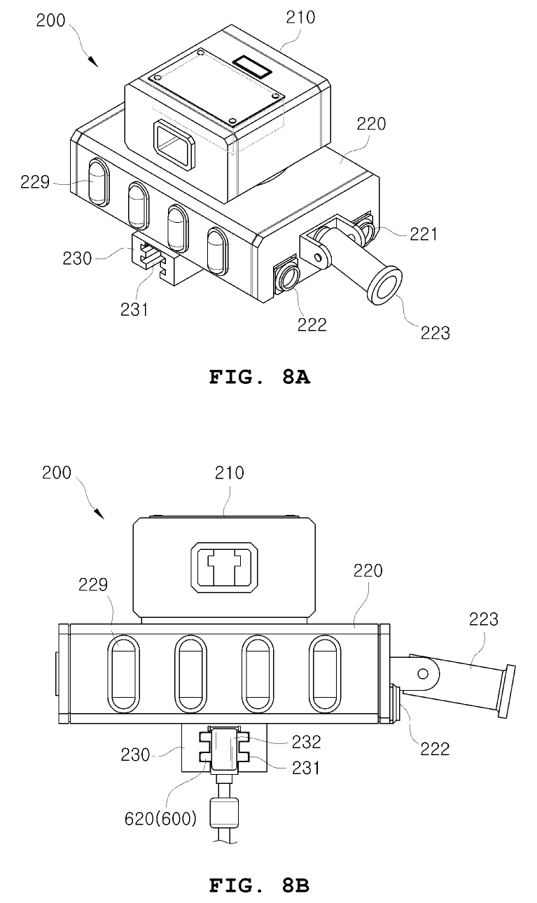

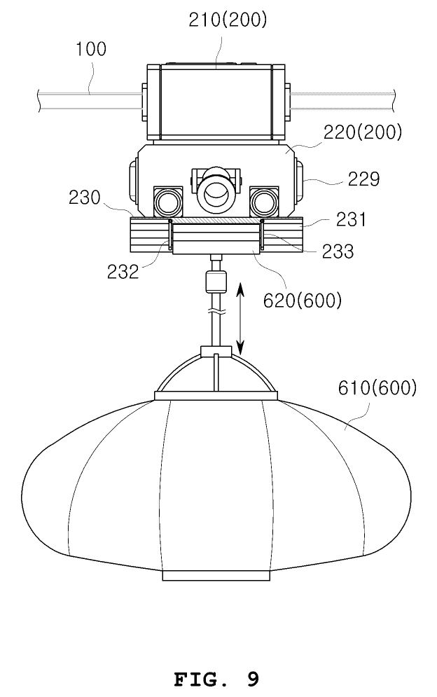

Meanwhile, in order to discharge a large amount of fire extinguishing water at once for fire suppression, the fire suppression mobile robot 200 may be configured to allow a bucket module 600 configured to store fire extinguishing water (e.g., water) to be coupled thereto. As an example, as shown in FIGS. 8A and 9, the fire suppression mobile robot 200 may further include a bucket moving rail 230 provided under the monitoring and suppression body 220, and the bucket module 600 may be coupled to the bucket moving rail 230.

In a specific example, the bucket module 600 may include a bucket 610 configured to receive fire extinguishing water and a bucket moving mechanism 620 configured to move the bucket 610 in the upward-downward direction, an upper end of the bucket moving mechanism 620 being coupled to the bucket moving rail 230. In this case, the fire extinguishing system according to the present invention may further include a bucket tank 700 provided at at least one point on the rail 100, the bucket tank 700 being configured to store fire extinguishing water. For example, the bucket 610 may be formed in a bucket shape with an upwardly open inlet and an outlet provided at a lower part thereof so as to be opened and closed, and the bucket tank 700 may be provided at an end of the rail 100 and formed in a bucket shape with an open upper surface configured to allow entry and exit of the bucket 610, wherein the bucket tank 700 may be larger than the bucket 610. Therefore, when the bucket 610 enters the bucket tank 700 through the bucket moving mechanism 620 in a state in which the fire suppression mobile robot 200 is located above the bucket tank 700, the bucket 610 may be submerged in the fire extinguishing water, whereby the fire extinguishing water may be received in the bucket 610, and the bucket 610 having the fire extinguishing water received therein may be lifted upward through the bucket moving mechanism 620, whereby the bucket module 600 may be in a movable state. In this state, the fire suppression mobile robot 200 may move so as to be located above the object where the fire has occurred, and may open the outlet of the bucket 610 above the object to suppress the fire with the fire extinguishing water.

The bucket moving rail 230 may be configured to transfer the bucket module 600 between the fire suppression mobile robots 200, which is based on the plurality of fire suppression mobile robots 200 moving along the same rail 100. As an example, the bucket moving rail 230 may be formed in a straight configuration and integrally coupled to a lower surface of the monitoring and suppression body 220. In this case, the bucket moving rail 230 may be provided in the inside thereof with a rail groove 231 configured to allow the bucket moving mechanism 620 to move therealong, wherein the upper end of the bucket moving mechanism 620 may be movably coupled to the rail groove 231.

Furthermore, in order to transfer the bucket module 600, two fire suppression mobile robots 200 must be located adjacent to each other. In particular, it is preferable for the bucket moving rails 230 of the fire suppression mobile robots 200 to be in contact with each other. Therefore, considering that the thermal imaging camera 221, the ultrasonic camera 222, and the fire nozzle 223 are provided at one end of the fire suppression mobile robot 200 so as to protrude outward, when the two fire suppression mobile robots 200 are located adjacent to each other, it is preferable for the bucket moving rail 230 to be coupled to the lower surface of the monitoring and suppression body 220 in a direction perpendicular to the direction in which the fire nozzle 223 protrudes in order to prevent damage to the thermal imaging camera 221, the ultrasonic camera 222, and the fire nozzle 223. Therefore, when the bucket module 600 is transferred, the monitoring and suppression body 220 with the bucket moving rail 230 coupled thereto is axially rotated such that the bucket moving rail 230 is oriented in the forward-backward direction.

Furthermore, the bucket module 600 may be transferred between adjacent fire suppression mobile robots 200 in various ways. As an example, the bucket module 600 may be transferred between the fire suppression mobile robots 200 due to the inertia caused by the abrupt stop of the fire suppression mobile robot 200 with the bucket module 600 coupled thereto. To this end, the bucket moving rail 230 may include a first movement restriction plate 232 and a second movement restriction plate 233 turnably provided on the rail groove 231, the first movement restriction plate 232 and the second movement restriction plate 233 being configured to open or close the rail groove 231 and to block or allow the movement of the bucket moving mechanism 620 in one direction and the other direction, respectively. In this case, the distance between the first movement restriction plate 232 and the second movement restriction plate 233 corresponds to the length of the upper end of the bucket moving mechanism 620, and when the rail groove 231 is closed in both directions by the first movement restriction plate 232 and the second movement restriction plate 233, the bucket moving mechanism 620 located between the first movement restriction plate 232 and the second movement restriction plate 233 may be in a fixed state.

Furthermore, when sudden stop of one fire suppression mobile robot 200 occurs, there is a risk of minor collision with another fire suppression mobile robot 200 that is to receive the bucket module 600 in a stopped state. Consequently, the monitoring and suppression body 220 with the bucket moving rail 230 coupled thereto may be provided on each of side surfaces thereof facing the same sides as both ends of the bucket moving rail 230 with a first shock-absorbing member 229. In addition, when the bucket module 600 is transferred at the charging station 400, the charging station 400 may be provided with a second shock-absorbing member 430 configured to absorb shock when the transfer bodies 210 of two adjacent fire suppression mobile robots 200 come into contact with each other while facing each other.

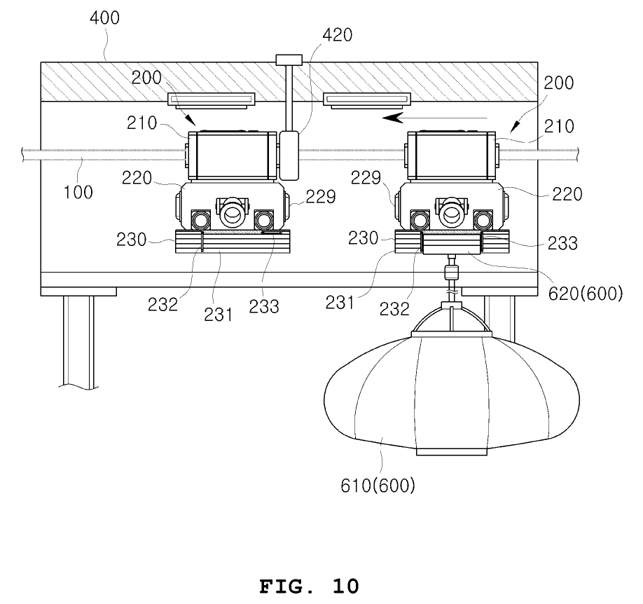

A specific example in which the bucket module 600 is transferred will be described. First, the bucket module 600 is coupled to the bucket moving rail 230, and one fire suppression mobile robot 200 with the rail groove 231 closed by the first movement restriction plate 232 and the second movement restriction plate 233 moves forward toward the other fire suppression mobile robot 200 in a stopped state, as shown in FIG. 10. At this time, the second movement restriction plate 233 of the other fire suppression mobile robot 200 may be rotated such that the rail groove 231 of the other fire suppression mobile robot 200 is open in the other direction (rearward).

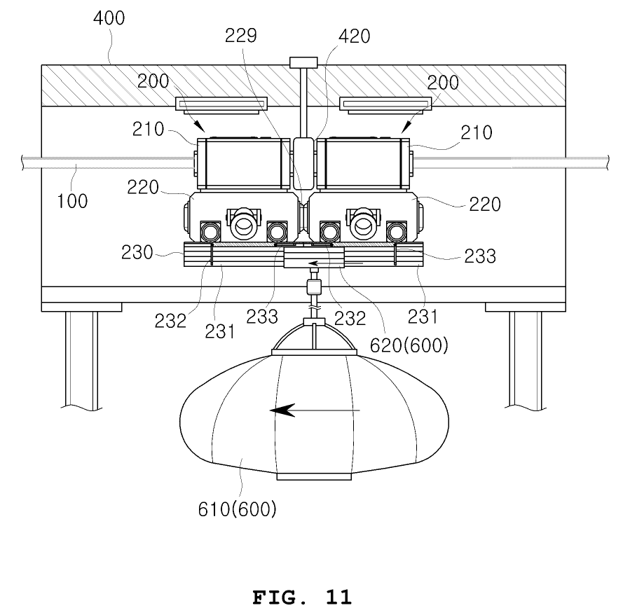

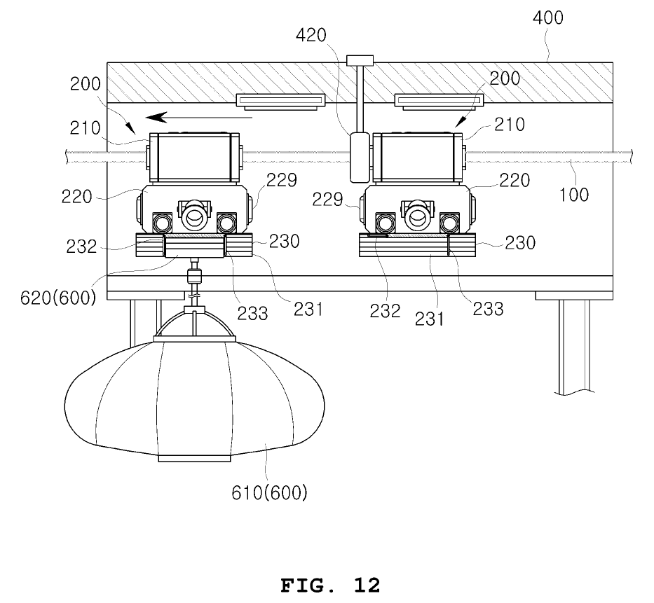

Subsequently, the rail groove 231 of the one fire suppression mobile robot 200 is opened in one direction (forward) by the first movement restriction plate 232 just before sudden stop of the one fire suppression mobile robot 200, and is suddenly stopped when the one fire suppression mobile robot 200 approaches the other fire suppression mobile robot 200. Accordingly, as shown in FIG. 11, the bucket moving rail 230 of the one fire suppression mobile robot 200 and the bucket moving rail 230 of the other fire suppression mobile robot 200 become adjacent to each other, and the bucket moving mechanism 620 moves in one direction due to inertia thereof, whereby the bucket module 600 is transferred from the one fire suppression mobile robot 200 to the other fire suppression mobile robot 200. The rail groove 231 of the other fire suppression mobile robot 200 that has received the bucket module 600 is closed by the first movement restriction plate 232 and the second movement restriction plate 233, and the other fire suppression mobile robot 200 states to move along the rail 100, as shown in FIG. 12.

The plurality of fire suppression mobile robots 200 moving within the respective partitioned sections of the same rail 100 may receive the bucket module 600 in a state of being adjacent to each other, and the bucket module 600 may be ultimately transferred to one of the fire suppression mobile robots 200 movable to the vicinity of the object where the fire has occurred. For example, the fire suppression mobile robots 200 located at the rear of the fire suppression mobile robot 200 movable to the vicinity of the object where the fire has occurred may continuously transfer the bucket 610 having fire extinguishing water received therein, and the fire suppression mobile robots 200 located in front of the fire suppression mobile robot 200 movable to the vicinity of the object where the fire has occurred may deliver the bucket 610 from which the fire extinguishing water has been discharged to the bucket tank 700.

As described above, the fire extinguishing system according to the present invention may quickly and effectively extinguish fires occurring in unconventional oil production plants, and may effectively extinguish fires while appropriately receiving the fire extinguishing agent and/or fire extinguishing water based on the type and scale of the fire.

As is apparent from the above description, the present invention has the effect that a fire suppression mobile robot monitors in real time whether a fire has occurred while moving along a rail provided near the facilities of a plant that produces unconventional oil, whereby it is possible to prevent the occurrence of the fire.

In addition, upon detecting a fire, the fire suppression mobile robot alerts a control server to notify both inside and outside the plant of the fire occurrence, and the fire suppression mobile robot sprays a fire extinguishing agent toward an object where the fire has occurred, whereby it is possible to achieve rapid early extinguishment of the fire and to minimize material and human damage caused by the fire.

Furthermore, it is possible to effectively extinguish the fire while appropriately receiving a fire extinguishing agent and/or fire extinguishing water depending on the type and scale of the fire.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

What is claimed is:

1. A fire extinguishing system for unconventional oil production plants, the fire extinguishing system comprising:
a rail provided at a predetermined height above a ground around facilities of a plant for producing unconventional oil;
a fire suppression mobile robot configured to monitor in real time whether a fire has occurred in the facility and in a vicinity of the facility while moving along the rail, to transmit a fire signal via a network upon detecting occurrence of the fire, and to spray a fire extinguishing agent onto an object where the fire has occurred; and
a control server configured to activate a fire alarm in the plant upon receiving the fire signal from the fire suppression mobile robot, to transmit the fire situation externally via the network, and to control movement and operation of the fire suppression mobile robot.

2. The fire extinguishing system according to claim 1, wherein
the fire suppression mobile robot comprises:
a transfer body movably coupled to the rail extending therethrough in a forward-backward direction, the transfer body being provided with an environmental sensor configured to measure a concentration of gas in air; and
a monitoring and suppression body coupled to a lower side of the transfer body, the monitoring and suppression body comprising a thermal imaging camera configured to capture a thermal image and a visible image, an ultrasonic camera configured to detect cracks or damage in the facility, and a fire nozzle configured to spray a fire extinguishing agent,
the monitoring and suppression body is coupled to the transfer body so as to rotate about a vertical axis, and
the thermal imaging camera, the ultrasonic camera, and the fire nozzle are configured to be turned in an upward-downward direction.

3. The fire extinguishing system according to claim 2, wherein the monitoring and suppression body is provided therein with a plurality of fire extinguishing agent storage tanks configured to store different types of fire extinguishing agents, respectively, a plurality of first transfer pipes connected to each of the fire extinguishing agent storage tanks, a second transfer pipe connected to the fire nozzle, a valve configured to allow one of the plurality of first transfer pipes and the second transfer pipe to communicate with each other therethrough, and a fire extinguishing agent pump provided on the second transfer pipe, the fire extinguishing agent pump being configured to spray the fire extinguishing agent stored in the fire extinguishing agent storage tank to the fire nozzle via the first transfer pipe and the second transfer pipe.

4. The fire extinguishing system according to claim 3, wherein
the fire suppression mobile robot further comprises a battery configured to supply electricity necessary for movement on the rail and electricity necessary for operation of components provided in the transfer body and the monitoring and suppression body, and
the fire extinguishing system further comprises a charging station provided at least one point on the rail, the charging station having a charging module configured to charge the battery.

5. The fire extinguishing system according to claim 4, further comprising:
a hose tank provided in a vicinity of the charging station, the hose tank being configured to store the same fire extinguishing agent as the fire extinguishing agent stored in any one of the plurality of fire extinguishing agent storage tanks, the hose tank being provided with a supply pump configured to supply the stored fire extinguishing agent to an outside, wherein
the charging station further comprises a fire hose having one end coupled to the monitoring and suppression body so as to communicate with the fire extinguishing agent storage tank in which the fire extinguishing agent is stored and the other end connected to the supply pump, the fire hose being configured to undergo continuous elastic coiling over a predetermined length, a coiled upper point of the fire hose being connected to the rail via a hose guide movable along the rail, and
when the fire suppression mobile robot moves along the rail after the one end of the fire hose is coupled to the monitoring and suppression body, a coiled part of the fire hose is uncoiled and moves along with the fire suppression mobile robot, and the fire extinguishing agent stored in the hose tank is supplied to the fire extinguishing agent storage tank by an operation of the supply pump.

6. The fire extinguishing system according to claim 2, wherein
the fire suppression mobile robot further comprises a bucket moving rail provided under the monitoring and suppression body, and
a bucket module configured to store fire extinguishing water is coupled to the bucket moving rail.

7. The fire extinguishing system according to claim 6, wherein
the fire suppression mobile robot is provided in plural so as to transfer the bucket module while moving along the same rail,
the bucket module comprises a bucket configured to receive fire extinguishing water and a bucket moving mechanism configured to move the bucket in the upward-downward direction, an upper end of the bucket moving mechanism being coupled to the bucket moving rail,
the bucket moving rail is formed in a straight configuration and integrally coupled to a lower surface of the monitoring and suppression body, the bucket moving rail being provided in an inside thereof with a rail groove configured to allow the bucket moving mechanism to move therealong such that both ends of the bucket moving rail in a longitudinal direction communicate with an outside, a first movement restriction plate and a second movement restriction plate configured to open or close the rail groove and to block or allow movement of the bucket moving mechanism in one direction and the other direction, respectively, being turnably provided on the rail groove,
the bucket module is coupled to the bucket moving rail, and one fire suppression mobile robot with the rail groove closed by the first movement restriction plate and the second movement restriction plate moves toward the other fire suppression mobile robot, and
when the one fire suppression mobile robot is suddenly stopped so as to be adjacent to the other fire suppression mobile robot in a state in which the rail groove of the one fire suppression mobile robot is opened in one direction by the first movement restriction plate of the one fire suppression mobile robot and the rail groove of the other fire suppression mobile robot is opened in the other direction by the second movement restriction plate of the other fire suppression mobile robot, the bucket moving rail of the one fire suppression mobile robot and the bucket moving rail of the other fire suppression mobile robot become adjacent to each other, and the bucket moving mechanism moves in one direction due to inertia thereof, whereby the bucket module is transferred from the one fire suppression mobile robot to the other fire suppression mobile robot.
